(19) United States
(12) Patent Application Publication
(10) Pub. No.: US 2019/0004348 A1
(43) Pub. Date: Jan. 3, 2019

(54) PLASTIC CELL AND METHOD FOR MANUFACTURING SAME

(71) Applicant: FUJIFILM Corporation, Tokyo (JP)

(72) Inventor: Junichi HIRAKATA, Minami-ashigara-shi (JP)

(73) Assignee: FUJIFILM Corporation, Tokyo (JP)

(21) Appl. No.: 16/113,805

(22) Filed: Aug. 27, 2018

Related U.S. Application Data
(63) Continuation of application No. PCT/JP2017/009367, filed on Mar. 9, 2017.

(30) Foreign Application Priority Data
Mar. 10, 2016 (JP) 2016-046982

(51) Int. Cl. G02F 1/1339; G02F 1/1341; G02F 1/1333; G02F 1/1343; G02F 1/1337; G02F 1/137

(52) U.S. Cl. CPC G02F 1/1339; G02F 1/1341; G02F 1/133305; G02F 2001/13775; G02F 1/133711; G02F 1/137; G02F 1/13439

(57) ABSTRACT

An object of the present invention is to provide a plastic cell and a method for manufacturing the same, in which a failure such as air bubbles does not occur in a case where a plastic cell using a plastic substrate is sealed by thermal fusion welding. The plastic cell of the present invention is a plastic cell including a first plastic substrate, a first transparent conductive layer, a fluid layer, a second transparent conductive layer, and a second plastic substrate, in this order, in which the plastic cell further includes a sealing part that seals the fluid layer, and the sealing part has at least a first sealing part and a second sealing part, the first sealing part being a sealing part which is formed by deformation of a part of the first plastic substrate or the second plastic substrate and occupying 80% to 99.5% with respect to the entire volume of the sealing part, and the second sealing part being a sealing part other than the first sealing part in the sealing part that seals the fluid layer.

### CROSS-REFERENCE TO RELATED APPLICATIONS

This application is a Continuation of PCT International Application No. PCT/JP2017/009367 filed on Mar. 9, 2017, which claims priority under 35 U.S.C. § 119(a) to Japanese Patent Application No. 2016-046982 filed on Mar. 10, 2016. The above application is hereby expressly incorporated by reference, in its entirety, into the present application.

### BACKGROUND OF THE INVENTION

### 1. Field of the Invention

The present invention relates to a plastic cell using a plastic substrate and a method for manufacturing the same.

### 2. Description of the Related Art

In recent years, liquid crystal display devices have evolved into various forms, and flexible displays which are light-weight and bendable have attracted attention. In liquid crystal cells used for such flexible displays, it is difficult to meet the requirements of being light-weight and bendable with a glass substrate which has been used in the related art. Thus, various types of plastic substrates have been studied as a substitute for the glass substrate.

Further, applications of a liquid crystal cell have spread to light control devices used for applications such as packaging, decoration, interior design, building materials, and vehicles. Also in such light control devices, it is desirable to use a liquid crystal cell which is light, has flexibility of being bendable, and further has a free shape with roughness and curved surfaces rather than a two-dimensional plane. Even in substrates for these applications, there is a need for practical use of a plastic substrate as a substitute for the glass substrate.

On the other hand, in a case of manufacturing a liquid crystal cell having flexibility, it is necessary that a sealing agent for sealing a liquid crystal compound in the liquid crystal cell also has flexibility.

As a sealing agent having such flexibility, for example, JP1987-18523A (JP-S62-18523A) discloses a sealing agent using an epoxy resin cured product to which flexibility has been imparted.

### SUMMARY OF THE INVENTION

On the other hand, in a case where a plastic substrate is used, it is conceivable to seal a liquid crystal cell by performing a thermal fusion welding of upper and lower plastic substrates.

However, in a case where sealing is carried out by performing a thermal fusion welding, it was found that, depending on the sealing method, air bubbles and the like are incorporated into an inside of the cell from an outside due to influences of the plastic substrate being physically pressed or bended, and it was also found that air bubbles and the like enter the inside of the cell for the reasons such as generation of gas components from the plastic substrate due to heating at the time of sealing.

Accordingly, an object of the present invention is to provide a plastic cell and a method for manufacturing the same, in which a failure such as air bubbles does not occur in a case where a plastic cell using a plastic substrate is sealed by thermal fusion welding.

As a result of intensive studies, the present inventors have found that occurrence of a failure such as air bubbles can be suppressed by allowing a sealing part of the plastic cell to have at least a first sealing part and a second sealing part, in which the first sealing part is a sealing part formed by thermal fusion welding of a first plastic substrate and a second plastic substrate, that is, a sealing part formed by deformation of a part of the first plastic substrate or the second plastic substrate, and allowing the first sealing part to be a sealing part occupying 80% to 99.5% with respect to the entire volume of the sealing part.

That is, it has been found that the object can be achieved by the following configuration.

[1] A plastic cell comprising:

a first plastic substrate, a first transparent conductive layer, a fluid layer, a second transparent conductive layer, and a second plastic substrate, in this order,

in which the plastic cell further comprises a sealing part that seals the fluid layer,

the sealing part has at least a first sealing part and a second sealing part,

the first sealing part is a sealing part which is formed by deformation of a part of the first plastic substrate or the second plastic substrate and which occupies 80% to 99.5% with respect to the entire volume of the sealing part, and

the second sealing part is a sealing part other than the first sealing part in the sealing part that seals the fluid layer.

[2] The plastic cell according to [1],

in which a part of the first sealing part and a part of the second sealing part are in contact with each other.

[3] The plastic cell according to [1],

in which at least one of the first plastic substrate or the second plastic substrate has a through-hole, and

the second sealing part is formed so as to close the through-hole.

[4] The plastic cell according to any one of [1] to [3], further comprising an orientation layer between the first conductive layer and the fluid layer and between the second conductive layer and the fluid layer, respectively,

in which the fluid layer is a liquid crystal layer formed by using a liquid crystal composition containing a liquid crystal compound.

[5] A method for manufacturing a plastic cell, comprising:

a precursor producing step of producing a plastic cell precursor having a first plastic substrate, a first transparent conductive layer, a fluid layer, a second transparent conductive layer, and a second plastic substrate, in this order; and

a sealing step of forming a sealing part that seals the fluid layer, in this order,

in which the sealing part has at least a first sealing part and a second sealing part, and

the sealing step has a first sealing step of forming the first sealing part by thermal fusion welding of the first plastic substrate and the second plastic substrate so that the first sealing part occupies 80% to 99.5% with respect to the entire volume of the sealing part, and a second sealing step of forming the second sealing part, in this order.

[6] The method for manufacturing a plastic cell according to [5], further comprising a step of removing air bubbles in the fluid layer, between the first sealing step and the second sealing step.

[7] The method for manufacturing a plastic cell according to [5] or [6], in which the second sealing step is a step of forming a part of the second sealing part so as to be in contact with a part of the first sealing part.

[8] The method for manufacturing a plastic cell according to [5] or [6], further comprising a step of forming a through-hole in at least one of the first plastic substrate or the second plastic substrate,

in which the second sealing step is a step of forming the second sealing part so as to close the through-hole.

[9] The method for manufacturing a plastic cell according to any one of [5] to [8],

in which the precursor producing step includes steps of:

forming the first transparent conductive layer on the first plastic substrate having an elongated shape;

forming the second transparent conductive layer on the second plastic substrate having an elongated shape;

disposing the fluid layer on the first transparent conductive layer; and

bonding the first plastic substrate, on which the first transparent conductive layer and the fluid layer are disposed, and the second plastic substrate, on which the second transparent conductive layer is disposed, to each other by a roll-to-roll process, to produce an elongated plastic cell precursor in which the first plastic substrate, the first transparent conductive layer, the fluid layer, the second transparent conductive layer, and the second plastic substrate are disposed, in this order.

[10] The method for manufacturing a plastic cell according to [9],

in which the first sealing step is a step of continuously forming a plurality of the first sealing parts with respect to the elongated plastic cell precursor.

[11] The method for manufacturing a plastic cell according to [10], further comprising a cutting step of cutting the elongated plastic cell precursor between the plurality of first sealing parts to produce a plastic cell unit, after the first sealing step and before the second sealing step.

According to the present invention, it is possible to provide a plastic cell and a method for manufacturing the same, in which a failure such as air bubbles does not occur in a case where a plastic cell using a plastic substrate is sealed by thermal fusion welding.

### BRIEF DESCRIPTION OF THE DRAWINGS

FIG. 1 is a schematic top view showing one embodiment of a plastic cell of the present invention.

FIG. 2 is a schematic top view showing one embodiment of the plastic cell of the present invention.

FIG. 3 is a schematic top view showing one embodiment of a plastic cell precursor used in the present invention.

FIG. 4 is a schematic top view showing one embodiment of a plastic cell unit used in the present invention.

FIG. 5 is a schematic top view showing one embodiment of the plastic cell of the present invention.

FIG. 6 is a schematic top view showing one embodiment of a heat source used in the present invention.

### DESCRIPTION OF THE PREFERRED EMBODIMENTS

Hereinafter, the present invention will be described in detail.

Descriptions of constituent elements described below are made based on representative embodiments of the present invention, but the present invention is not limited to such embodiments.

In the present specification, a numerical range expressed using “to” means a range including numerical values described before and after the preposition “to” as a lower limit value and an upper limit value.

Further, in the present specification, “cutting” includes “punching”, “slicing”, and the like.

In the present specification, “sealing” as used herein means a step of hermetically sealing a fluid layer so that fluid in the fluid layer does not leak out. However, in the description of the present specification, in a case of “sealing part” (for example, a first sealing part or the like), fluid may not necessarily be hermetically sealed in a case where the sealing part is formed. It is sufficient that the fluid layer is hermetically sealed in a case where a final plastic cell is manufactured.

<Plastic Cell>

The plastic cell of the present invention includes a first plastic substrate, a first transparent conductive layer, a fluid layer, a second transparent conductive layer, and a second plastic substrate, in this order.

Further, the plastic cell of the present invention includes a sealing part that seals the fluid layer.

Furthermore, in the plastic cell according to the present invention, the sealing part has at least a first sealing part and a second sealing part, and the first sealing part is a sealing part which is formed by deformation of a part of the first plastic substrate or the second plastic substrate and which occupies 80% to 99.5% with respect to the entire volume of the sealing part.

[Plastic Substrate]

Both the first plastic substrate and the second plastic substrate (hereinafter simply abbreviated as “plastic substrate” in a case where distinction is not particularly required) of the plastic cell of the present invention are a substrate used from the viewpoint of achieving a high degree of freedom in moldability.

In a case of manufacturing a plastic cell, since dimensional changes such as stretching and shrinkage occur locally, it is preferable to use a thermoplastic resin as the plastic substrate.

As the thermoplastic resin, a polymer resin which is excellent in optical transparency, mechanical strength, thermal stability, and the like is preferable.

Examples of the polymer included in the thermoplastic resin include polycarbonate-based polymers; polyester-based polymers such as polyethylene terephthalate (PET); acrylic polymers such as polymethyl methacrylate (PMMA); styrene-based polymers such as polystyrene and acrylonitrile-styrene copolymers (AS resins); and the like.

Further, polyolefins such as polyethylene and polypropylene; polyolefin-based polymers such as norbornene-based resins and ethylene-propylene copolymers; vinyl chloride-based polymers; amide-based polymers such as nylon and aromatic polyamide; imide-based polymers; sulfone-based polymers; polyether sulfone-based polymers; polyether ether ketone-based polymers; polyphenylene sulfide-based polymers; vinylidene chloride-based polymers; vinyl alcohol-based polymers; vinyl butyral-based polymers; arylate-based polymers; polyoxymethylene-based polymers; epoxy-based polymers; cellulosic polymers typified by triacetyl cellulose; copolymers copolymerized with monomer units of these polymers; or the like can be mentioned.

Further, examples of the thermoplastic resin include polymers obtained by mixing two or more of the polymers exemplified above.

[Transparent Conductive Layer]

Both the first transparent conductive layer and the second transparent conductive layer (hereinafter simply abbreviated as “transparent conductive layer” in a case where distinction is not particularly required) of the plastic cell of the present invention are a layer having conductivity and disposed on the plastic substrate.

In the present invention, “having conductivity” means that a sheet resistance value is 0.1 Ω/square to 10,000 Ω/square, and generally also includes those called an electric resistance layer.

Further, in a case of being used as an electrode of a flexible display device or the like, the sheet resistance value is preferably low; specifically, it is preferably 300 Ω/square or less, particularly preferably 200 Ω/square or less, and most preferably 100 Ω/square or less.

In the transparent conductive layer used in the present invention, “transparent” means that a transmittance is 60% or more and 99% or less.

The transmittance of the transparent conductive layer is preferably 75% or more, particularly preferably 80% or more, and most preferably 90% or more.

As materials that can be used for the transparent conductive layer used in the present invention, metal oxides (Indium Tin Oxide: ITO and the like), carbon nanotubes (Carbon Nanotube: CNT, Carbon Nanobud: CNB, and the like), graphene, polymer conductors (polyacetylene, polypyrrole, polyphenol, polyaniline, PEDOT/PSS, and the like), metal nanowires (silver nanowires, copper nanowires, and the like), metal mesh (silver mesh, copper mesh, and the like), and the like can be used.

Here, “PEDOT/PSS” means a polymer complex in which PEDOT (polymer of 3,4-ethylenedioxythiophene) and PSS (polymer of styrene sulfonic acid) coexist.

Further, a conductive layer of the metal mesh is preferably formed by dispersing conductive fine particles of silver, copper, or the like in a matrix rather than being formed only of a metal.

A metal oxide such as ITO is a ceramic material and has a problem that cracks are easily formed by a stretching action to remarkably increase the sheet resistance value in a case of being molded without utilizing shrinkage as in technologies of the related art. On the other hand, in the present invention, generation of cracks can be suppressed by utilizing shrinkage, and the problem of exhibiting a high sheet resistance value, which has been a problem in the related art, can be improved so that such material can be used as a transparent conductive layer.

A conductive layer in which particles such as metal mesh form, carbon nanotube form or metal nanowires are dispersed in a matrix can easily follow shrinkage of the plastic substrate by making a glass transition temperature (Tg) of the matrix equal to or lower than a shrinkage temperature of the plastic substrate and is preferable because such conductive layer can suppress generation of wrinkles and suppress increase of haze as compared with a conductive layer using a metal oxide and a polymer conductor.

[Orientation Layer]

In the plastic cell of the present invention, an orientation layer may be comprised between the transparent conductive layer provided on the plastic substrate and the fluid layer described later. In a preferred embodiment, the orientation layer is provided on the uppermost surface of each of the first plastic substrate and the second plastic substrate used for the plastic cell, and allows the plastic cell to have a function of orientating the fluid layer containing a liquid crystal compound.

In a case where no voltage is applied, the orientation layer used in the present invention may be an orientation layer for horizontally orientating the liquid crystal compound contained in the fluid layer or an orientation layer for vertically orientating the same.

Materials for the orientation layer and treatment methods thereof are not particularly limited, and it is possible to use various orientation layers such as an orientation layer using a polymer, an orientation layer obtained by being subjected to a silane coupling treatment, an orientation layer using a quaternary ammonium salt, an orientation layer obtained by depositing silicon oxide from an oblique direction, and an orientation layer utilizing photoisomerization. In addition, as a surface treatment for the orientation layer, a surface treatment performed by rubbing treatment, energy ray irradiation, photo-irradiation, or the like may be used.

The orientation layer using a polymer preferably includes any one of a layer using a polyamic acid or a polyimide; a layer using a modified or unmodified polyvinyl alcohol; a layer using a modified or unmodified polyacrylic acid; or a layer using a (meth)acrylic acid copolymer containing any one of a repeating unit represented by General Formula (I), a repeating unit represented by General Formula (II), or a repeating unit represented by General Formula (III).

Further, “(meth)acrylic acid” is a description representing acrylic acid or methacrylic acid.

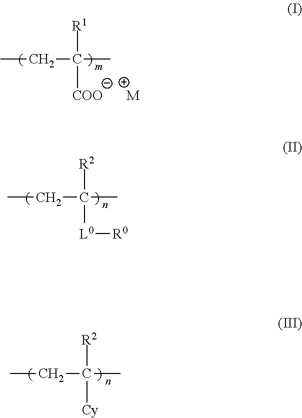

In General Formulas (I) to (III), R¹ and R² each independently represent a hydrogen atom, a halogen atom, or an alkyl group having 1 to 6 carbon atoms; M represents a proton, an alkali metal ion, or an ammonium ion; L° is a divalent linking group selected from the group consisting of —O—, —CO—, —NH—, —SO₂—, an alkylene group, an alkenylene group, an arylene group, and a combination thereof; R⁰ is a hydrocarbon group having 10 to 100 carbon atoms or a fluorine atom-substituted hydrocarbon group having 1 to 100 carbon atoms; Cy is an alicyclic group, aromatic group, or heterocyclic group, particularly preferably, having a carbazole group; m is 10 to 99 mol %; and n is 1 to 90 mol %.

Among these, it is preferable to use an orientation layer containing any one of polyimide, compounds represented by General Formulas (I) to (III), and a silane coupling agent from the viewpoints of orientation capability, durability, insulation property, and costs; and it is particularly preferable to use an orientation layer containing any one of polyimide or compounds represented by General Formulas (I) to (III) and having a carbazole group.

Further, as the orientation layer, a photo-orientation layer capable of orientating a liquid crystal by irradiation with polarized and unpolarized ultraviolet (UV) light may be used.

[Fluid Layer]

The fluid layer of the plastic cell of the present invention is not particularly limited as long as it is a continuous body having fluidity other than gas and plasma fluid.

As a particularly preferred substance state, a liquid and a liquid crystal are preferable, and as the fluid layer, a liquid crystal layer formed by using a liquid crystal composition containing a liquid crystal compound is most preferable.

Here, in general, the liquid crystal compound can be classified into a rod-like type and a disk-like type depending on its shape. These types further have a low molecule type and a high molecule type, respectively. The high molecule generally refers to one having a degree of polymerization of 100 or more (Polymer Physics-Phase Transition Dynamics, by Masao Doi, p. 2, published by Iwanami Shoten, Publishers, 1992). In the present invention, any liquid crystal compound can be used. However, it is preferable to use a rod-like liquid crystal compound or a discotic liquid crystal compound (disk-like liquid crystal compound). Two or more rod-like liquid crystal compounds, two or more disk-like liquid crystal compounds, or a mixture of the rod-like liquid crystal compound and the disk-like liquid crystal compound may be used. In order to immobilize the above-described liquid crystal compound, it is more preferable to use a rod-like liquid crystal compound or disk-like liquid crystal compound having a polymerizable group to form the liquid crystal compound, and the liquid crystal compound still more preferably has two or more polymerizable groups in one molecule. In a case of using a mixture of two or more liquid crystal compounds, it is preferable that at least one liquid crystal compound has two or more polymerizable groups in one molecule.

The plastic cell of the present invention is preferably an embodiment in which the above-described fluid layer is a liquid crystal layer, that is, a liquid crystal cell.

Here, the liquid crystal cell means a liquid crystal cell used for liquid crystal display devices used for a thin television, a monitor, a notebook computer, a cellular phone, and the like, and a liquid crystal cell used for light control devices for changing intensity of light which is applied to interior design, building materials, vehicles, and the like. That is, the liquid crystal cell is a general term for devices that adjust a voltage to drive a liquid crystal composition having a polarizability such as a liquid crystal composition sealed between two substrates.

As a driving mode of the liquid crystal cell, various methods including in-plane-switching (IPS), vertical alignment (VA), twisted nematic (TN), and super twisted nematic (STN) can be used.

Further, inside the cell in the plastic cell of the present invention, colorant molecules and the like used for changing intensity of light in a light control element may be used in combination.

Further, depending on a configuration of the liquid crystal cell, a backlight member, a polarizing plate member, a member for controlling a surface reflection, or the like may be used by juxtaposition or bonding on an outside of the liquid crystal cell.

[Sealing Part]

The plastic cell of the present invention has a sealing part that seals the above-described fluid layer.

Further, in the present invention, the sealing part has at least a first sealing part and a second sealing part.

Furthermore, in the present invention, the first sealing part is a sealing part which is formed by deformation of a part of the first plastic substrate or the second plastic substrate and which occupies 80% to 99.5% with respect to the entire volume of the sealing part, and the second sealing part is a sealing part other than the first sealing part in the entire sealing part that seals the fluid layer.

The sealing part means, among parts which surround the fluid layer in the plastic cell, a part other than parts sandwiching the fluid layer from above and below in a laminated structure of the first plastic substrate, the first transparent conductive layer, the fluid layer, the second transparent conductive layer, and the second plastic substrate as described above. However, in a case where the sealing part is formed by thermal fusion welding of the first plastic substrate and the second plastic substrate, since there is no distinction between the plastic substrate and the sealing part in terms of material, an area protruding or recessing in a vertical direction with respect to a plane of the plastic substrate is set as a sealing part.

In the plastic cell of the present invention, the fluid layer contained inside by the sealing part does not leak out and generation of air bubbles or the like in the fluid layer can be suppressed.

That is, after forming the first sealing part, which occupies 80% to 99.5% with respect to the entire volume of the sealing part, by thermal fusion welding, it is possible to form the second sealing part while escaping air bubbles present in the fluid layer and suppressing generation of air bubbles.

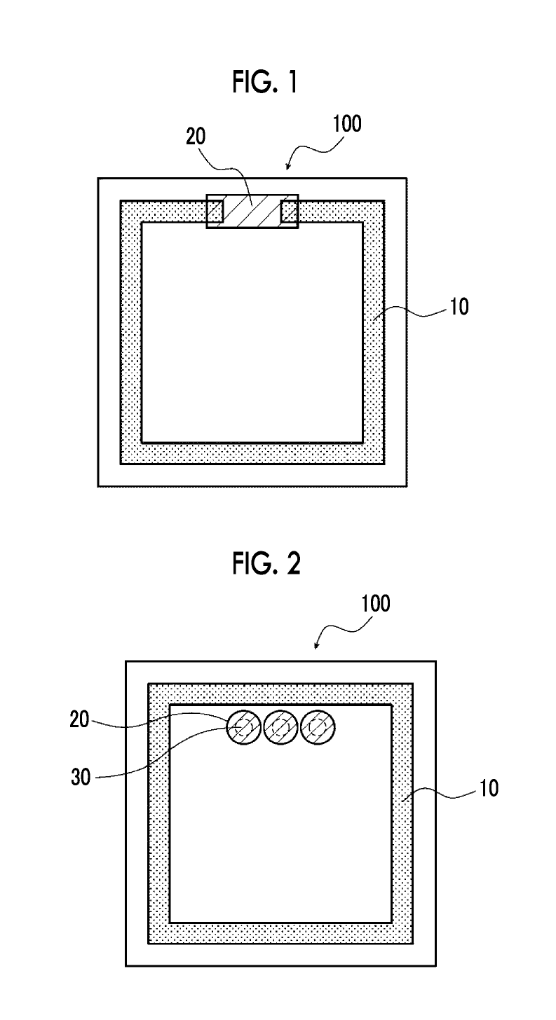

As a specific embodiment of the sealing part, for example, an embodiment having a first sealing part 10 and a second sealing part 20 as in a plastic cell 100 shown in FIG. 1 can be mentioned.

{First Sealing Part}

The first sealing part is a sealing part which is formed by thermal fusion welding of the first plastic substrate or the second plastic substrate as described above, that is, a sealing part formed by deformation of a part of the first plastic substrate or the second plastic substrate, and which occupies 80% to 99.5% with respect to the entire volume of the sealing part. A proportion occupied by the first sealing part is preferably 83% to 99.5%, and more preferably 87% to 99.5%.

By setting the proportion occupied by the first sealing part to 80% or more, it is possible to prevent the fluid layer from leaking out before forming the second sealing part as described later.

Further, by setting the proportion occupied by the first sealing part to 99.5% or less, in a case where air bubbles are present in the fluid layer after forming the first sealing part, it is possible to eliminate the air bubbles and then form the second sealing part.

{Second Sealing Part}

The second sealing part is a sealing part other than the above-mentioned first sealing part in the entire sealing part that seals the fluid layer. A method of forming the second sealing part is not particularly limited, and sealing by thermal fusion welding may be used, or sealing using a sealing material or an adhesive may be used.

In the present invention, after the first sealing part is formed, the second sealing part may be formed so that an unsealed part of the fluid layer is sealed and a partial area of the second sealing part is in contact with a part of the first sealing. In the present invention, as shown in FIG. 1, in a case where a part of the first sealing part 10 and a part of the second sealing part 20 are in contact with each other so as to overlap each other, the overlapping part is regarded as the first sealing part.

Further, in the present invention, regarding the first sealing part and the second sealing part, as shown in FIG. 2, after sealing the fluid layer with the first sealing part 10, a through-hole 30 communicating with a conductive layer may be formed in the plastic substrate or the first sealing part and the second sealing part 20 may be formed so as to close the hole. A method for forming the through-hole 30 is not particularly limited, and various known methods can be used.

Further, from the viewpoint of making air bubbles easier to escape, the second sealing part may be formed in a state where an internal pressure of the plastic cell is increased. As a method of increasing the internal pressure, a method of uniformly pushing the plastic cell and a method of relatively increasing the internal pressure by depressurizing a system including the plastic cell can be mentioned.

In the plastic cell of the present invention, a planar shape may be a rectangular shape. The rectangular shape may be a square or an oblong, and there is no limitation on a size.

Further, in the plastic cell of the present invention, the planar shape may be a shape other than a rectangle. For example, the planar shape may be a circle, an ellipse, a triangle, a pentagon or higher polygon, or a free shape obtained by combination of a straight line and a curved line, or may be a shape that is hollow on the inside like a donut shape in a case where a periphery of the plastic cell is sealed.

Furthermore, in the plastic cell of the present invention, an elongated film can be used as the first plastic substrate and second plastic substrate. Thus, it is also possible to form the plastic cell and then wind it in a longitudinal direction into a roll form. This can contribute to packing, shipping, transportation, and the like of the plastic cell of the present invention.

[Electrode]

In the plastic cell of the present invention, in order to apply a driving voltage, an electrode connected to the transparent conductive layer may be installed via a conductive material.

As an installation method, for example, a method of manufacturing a plastic cell after installing an electrode in advance on a transparent conductive layer on a plastic substrate; a method in which after a plastic cell is manufactured, for connection to a transparent conductive layer, a conductive material such as a silver paste, a conductive tape, or the like is used to connect to a lead terminal, or the like; a method in which after a first sealing part is formed by thermal fusion welding and a lead terminal is connected to a transparent conductive layer of an unsealed part, the unsealed part is closed by forming a second sealing part while installing an electrode; and the like can be mentioned.

<Method for Manufacturing Plastic Cell>

The method for manufacturing a plastic cell of the present invention (hereinafter also abbreviated as “manufacturing method of the present invention”) includes a precursor producing step of producing a plastic cell precursor having the first plastic substrate, the first transparent conductive layer, the fluid layer, the second transparent conductive layer, and the second plastic substrate, in this order, and a sealing step of forming a sealing part that seals the fluid layer, in this order.

[Precursor Producing Step]

In the manufacturing method of the present invention, the precursor producing step is a step of producing a laminate having the first plastic substrate, the first transparent conductive layer, the fluid layer, the second transparent conductive layer, and the second plastic substrate, in this order. That is, the laminate (plastic cell precursor) produced in the precursor producing step is in a state where a periphery of the fluid layer is not sealed.

In the step of producing the plastic cell precursor, the first plastic substrate and the second plastic substrate may have an elongated shape. By adopting the elongated shape, it is possible to continuously produce the plastic cell of the present invention.

In a case where the plastic substrate has an elongated shape, the precursor producing step includes a step of forming a first transparent conductive layer on a first elongated plastic substrate (hereinafter, abbreviated as “conductive layer disposing step 1”),

a step of forming a second transparent conductive layer on a second elongated plastic substrate (hereinafter, abbreviated as “conductive layer disposing step 2”),

a step of disposing the fluid layer on the first transparent conductive layer (hereinafter, abbreviated as “fluid layer disposing step”), and

a step of bonding the first plastic substrate, on which the first transparent conductive layer and the fluid layer are disposed, and the second plastic substrate, on which the second transparent conductive layer is disposed, to each other by a roll-to-roll process, to produce an elongated plastic cell precursor in which the first plastic substrate, the first transparent conductive layer, the fluid layer, the second transparent conductive layer, and the second plastic substrate are disposed, in this order (hereinafter, abbreviated as “laminate producing step”).

Hereinafter, the conductive layer disposing step 1 and the conductive layer disposing step 2 (hereinafter, simply abbreviated as “conductive layer disposing step” in a case where distinction is not particularly required), and the fluid layer disposing step, the laminate producing step, and the sealing step will be described in detail.

{Conductive Layer Disposing Step}

In the manufacturing method of the present invention, the conductive layer disposing step 1 is a step of disposing the first transparent conductive layer on the first elongated plastic substrate, and the conductive layer disposing step 2 is a step of disposing the second transparent conductive layer on the second elongated plastic substrate.

Here, the method of disposing the transparent conductive layer on the plastic substrate is not particularly limited, and the material usable for the transparent conductive layer described in the plastic cell of the present invention may, for example, be disposed by a method such as coating, vapor deposition, or printing.

{Fluid Layer Disposing Step}

In the manufacturing method of the present invention, the fluid layer disposing step is a step of disposing the fluid layer on the first transparent conductive layer.

Here, the method of disposing the fluid layer on the first transparent conductive layer is not particularly limited, and various known methods such as coating, dipping, and injection utilizing capillary phenomenon can be used.

{Laminate Producing Step}

In the manufacturing method of the present invention, the laminate producing step is a step of bonding the first plastic substrate, on which the first transparent conductive layer and the fluid layer are disposed, and the second plastic substrate, on which the second transparent conductive layer is disposed, to each other by a roll-to-roll process, to produce an elongated laminate.

Here, the method of performing the bonding by a roll-to-roll process is not particularly limited, and, for example, a method of passing the first plastic substrate, on which the first transparent conductive layer and the fluid layer are disposed, and the second plastic substrate, on which the second transparent conductive layer is disposed, between nip rolls to achieve bonding, or the like can be used.

[Sealing Step]

In the manufacturing method of the present invention, the sealing step includes a first sealing step of forming a first sealing part by thermal fusion welding of the first plastic substrate and the second plastic substrate so that the first sealing part occupies 80% to 99.5% with respect to the entire volume of the sealing part, and a second sealing step of forming a second sealing part, in this order.

A method of performing a thermal fusion welding is not particularly limited as long as a method of giving energy required for thermal fusion welding to a plastic substrate is used. Specifically, a method of bringing a high-temperature metal element into contact with the plastic substrate, a method of concentrating a COx laser to the plastic substrate, a method of applying ultrasonic waves to the plastic substrate, and the like.

{First Sealing Step}

In the first sealing step, a thermal fusion welding of the first plastic substrate and the second plastic substrate are carried out so that the first sealing part occupies 80% to 99.5% with respect to the entire volume of the sealing part.

Further, in the first sealing step, the first sealing part is preferably a sealing part occupying 83% to 99.5% with respect to the entire volume of the sealing part, and more preferably a sealing part occupying 87% to 99.5%.

Further, in a case of using an elongated plastic substrate, the first sealing step may be performed a plurality of times on the plastic cell precursor. That is, a plurality of first sealing parts may be formed continuously with respect to the plastic precursor. Thereafter, the second sealing step as described later may be performed a plurality of times to form a plurality of second sealing parts.

{Second Sealing Step}

The second sealing step is a step of forming a second sealing part with respect to an area (unsealed part) where the first sealing part is not formed.

A method of forming the second sealing part is not particularly limited, and sealing by thermal fusion welding may be used, or sealing using a sealing material or an adhesive may be used.

In the present invention, the second sealing part may be formed so that an unsealed part of the fluid layer is sealed and a partial area of the second sealing part is in contact with a part of the first sealing part.

Further, after the fluid layer is completely sealed with the first sealing part, a through-hole may be formed in the plastic substrate or the first sealing part, and the second sealing part may be formed so as to close the hole.

A method for forming the through-hole is not particularly limited, and various known methods can be used.

[Step of Removing Air Bubbles]

The manufacturing method of the present invention may include a step of removing air bubbles in the fluid layer between the first sealing step and the second sealing step in the sealing step.

Further, from the viewpoint of facilitating removal of the air bubbles or preventing re-incorporation of the removed air bubbles, the plastic cell may be in a state where an internal pressure thereof is increased.

Further, from the step of removing air bubbles to the second sealing step, the state where the internal pressure is increased may continue.

As a method of increasing the internal pressure, a method of uniformly pushing the plastic cell and a method of relatively increasing the internal pressure by depressurizing a system including the plastic cell can be mentioned.

[Cutting Step]

In a case where a plurality of first sealing parts are continuously formed with respect to the elongated plastic cell precursor in the first sealing step, the manufacturing method of the present invention may further include a cutting step of cutting the elongated plastic cell precursor between the plurality of first sealing parts to produce a plastic cell unit, between the first sealing step and the second sealing step.

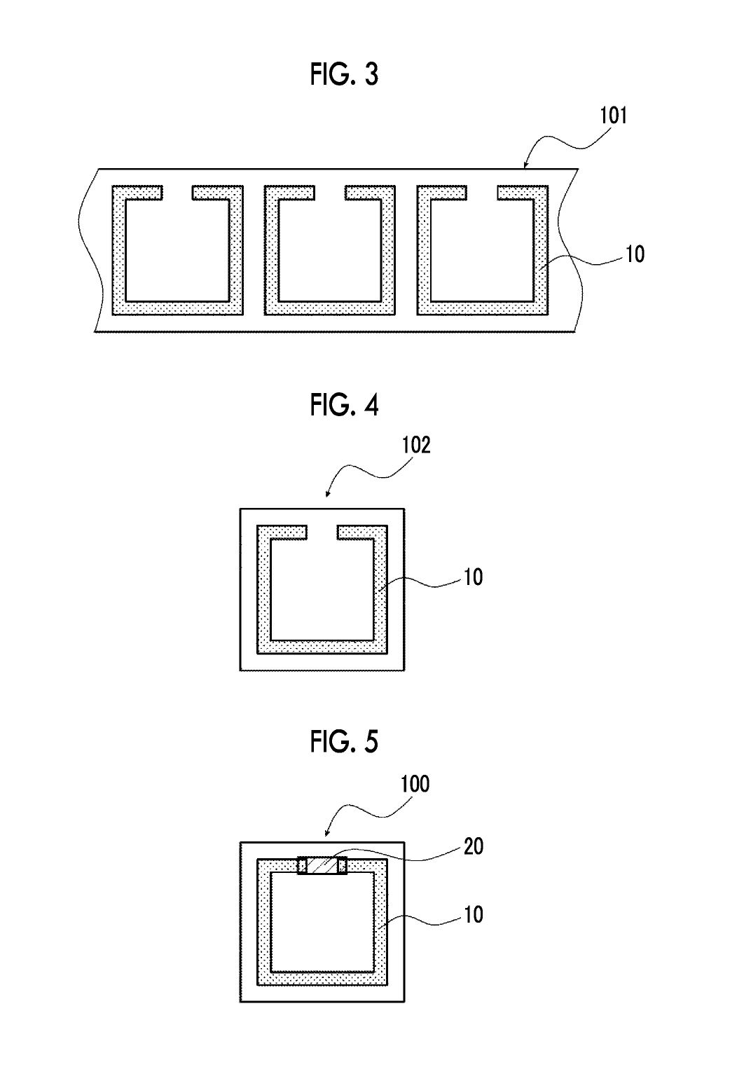

For example, as shown in FIG. 3, after the first sealing step is continuously carried out for the elongated plastic precursor 101 to form a plurality of first sealing parts 10, as shown in FIG. 4, the plastic precursor may be cut off at an outside of the first sealing part, respectively, to produce plastic cell units 102 each having at least one first sealing part 10, and as shown in FIG. 5, the second sealing step may be carried out for the individual plastic cell unit, respectively, so as to form a second sealing part 20, thereby manufacturing a plurality of plastic cells 100. At this time, after the first sealing step, it may be first wound in a roll state.

### EXAMPLES

Hereinafter, the present invention will be specifically described with reference to examples. However, the materials, reagents, substance amounts and proportions thereof, conditions, operations, and the like shown in the following examples can be appropriately changed within a scope that does not depart from the gist of the present invention. Accordingly, a scope of the present invention is not limited to the following examples.

### Example 1

<Production of Transparent Conductive Layer>

A transparent conductive layer was produced with Ag nanowire by a method described in Example 1 of US2013/0341074A on a surface of a polycarbonate (PC-2151, thickness of 250 μm, width of 1.05 m) manufactured by Teijin Limited, and a laminate in which a plastic substrate formed of the polycarbonate and the transparent conductive layer formed of Ag nanowire were laminated was obtained. The obtained laminate was wound up to produce a roll having a length of 100 m.

<Production of Orientation Layer>

The laminate produced above was coated with a polyamic acid orientation layer coating solution (JALS684, manufactured by JSR Corporation) as a liquid crystal orientating agent using a bar coater #1.6.

Thereafter, the resulting laminate was dried at a film surface temperature of 80° C. for 3 minutes to produce an orientation layer 101. At this time, a film thickness of the orientation layer was 60 nm.

Two sets of laminates produced in this manner, in each of which the plastic substrate, the transparent conductive layer, and the orientation layer were laminated in this order, were prepared as rolls of 50 m in length.

<Production of Spacer Layer>

A spacer layer dispersion liquid was produced by using the following formulation.

Formulation of spacer layer dispersion liquid

| | |
|---|---|
| Bead spacer SP-208 (manufactured by Sekisui | 100 parts by mass |
| Chemical Co., Ltd.) | |
| Methyl isobutyl ketone | amount to give solid |
| | content of 0.2% |

The produced spacer layer dispersion liquid was coated on each of the two sets of the laminates, in which the orientation layer was laminated, using an applicator with a clearance setting of 100 μm.

Thereafter, the laminate was heated so that a film surface temperature thereof was 60° C., and dried for 1 minute to produce two sets of laminates having a spacer layer as rolls of 50 m in length.

<Manufacture of Plastic Cell>

A liquid crystal layer composition was produced by using the following formulation.

Liquid crystal layer composition

| | | |
|---|---|---|
| ZLI 2806 (manufactured by Merck KGaA) | 100 | parts by mass |
| Cholesteric nonanate (manufactured by Tokyo | 1.74 | parts by mass |
| Chemical Industry Co., Ltd.) | | |
| G-472 (manufactured by Hayashibara Co., Ltd.) | 3.00 | parts by mass |

The two sets of rolls of the laminate having the spacer layer produced above were continuously fed, and one of the rolls was continuously coated with the liquid crystal layer composition as produced above using a bar coater at a width of 90 cm. Thereafter, the other uncoated laminate having a spacer layer was superimposed thereon and sandwiching was carried out in a roll-to-roll process with a nip roller to produce a plastic cell precursor.

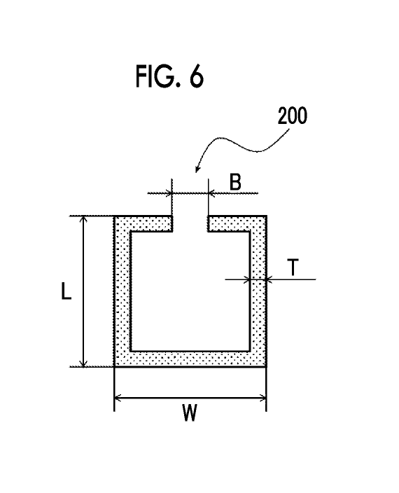

While transporting the plastic precursor, a heat source 200 having a temperature of 250° C. was brought into contact therewith for 5 seconds from above and below in a shape shown in FIG. 6 (length L=90 cm, width W=90 cm, thickness T=1 cm, gap width B=3 cm) so that a thermal fusion welding of the two plastic substrates was carried out to form the first sealing part. At this time, in a part corresponding to a gap of the heat source, the first sealing part was not formed. In addition, several air bubbles having a diameter of about 1 mm were generated in the gap part of the heat source.

Next, as shown in FIG. 3, a plurality of first sealing parts were continuously formed so that each interval between the sealing parts was 5 cm.

Thereafter, as shown in FIG. 4, at the center between the two first sealing parts, the plastic cell precursor was cut and a plastic cell unit was produced.

A linear heat source having a length of 6 cm, a width of 1 cm, and a temperature of 280° C. was brought into contact with a part not formed with the first sealing part in the above-produced plastic cell unit for 5 seconds from above and below, so that a thermal fusion welding of the two plastic substrates was carried out to be in contact with the first sealing part, thereby forming the second sealing part, and a plastic cell 1 as shown in FIG. 5 was manufactured.

In a case where the second sealing part was formed, the second sealing part was formed while pushing several air bubbles having a diameter of about 1 mm to an outside of the plastic cell by applying a slight pressure above and below the plastic cell. Here, a proportion of the first sealing part to the entire sealing part was 98.3%.

### Example 2

The first sealing part was formed so as to completely seal the liquid crystal layer in the same procedure as in Example 1 except that, as the heat source forming the first sealing part, a heat source having no gap was used. At this time, several air bubbles having a diameter of about 1 mm were generated in the liquid crystal layer.

Next, as shown in FIG. 2, in one plastic substrate, three through-holes having a diameter of 0.5 cm were formed inside the first sealing part.

After that, a slight pressure was applied from above and below the plastic cell to push the air bubbles to an outside of the plastic cell, and a UV sealant TB1220 (manufactured by ThreeBond Holdings Co., Ltd.) having a diameter of 2 cm was placed on the three through-holes, and UV curing was carried out so that the second sealing part was formed to close the through-holes, thereby manufacturing the plastic cell 2. Here, a proportion of the first sealing part to the entire sealing part was 97.4%.

### Example 3

A plastic cell 3 was manufactured in the same manner as in Example 1 except that the heat source forming the first sealing part had a shape with a length L=90 cm, a width W=90 cm, a thickness T=1 cm, and a gap width B at one side only=52 cm, and the heat source forming the second sealing part had a length of 56 cm and a width of 1 cm. Here, a proportion of the first sealing part to the entire sealing part was 84.4%.

In any of the plastic cells 1, 2 and 3 manufactured as described above, in a case of forming the second sealing part, it is possible to push air bubbles to an outside of the cell without causing a liquid crystal composition inside the cell to leak out to an outside of the cell.

Further, in order to check flexibility, these plastic cells were bent by 90° near the center. It was checked that, in any case, there was no leakage of the liquid crystal composition inside thereof and there was no problem in the sealing part.

### Comparative Example 1

An attempt to manufacture a plastic cell 4 was made in the same manner as in Example 1 except that the heat source forming the first sealing part had a shape with a length L=90 cm, a width W=90 cm, a thickness T=1 cm, and a gap width B at one side only=88 cm, and the heat source forming the second sealing part had a length of 92 cm and a width of 1 cm.

However, due to the fact that a volume of the first sealing part was small and an opening part of the plastic cell was large, in a case of attempting to push air bubbles to an outside of the plastic cell at the time of forming the second sealing part, the liquid crystal composition inside the plastic cell leaked out to an outside of the cell.

As a result, the portion where the liquid crystal composition inside the cell was insufficient turned into bubbles, and the plastic cell 4 contained air bubbles. A proportion of the first sealing part to the entire sealing part was 74.4%.

### EXPLANATION OF REFERENCES

100: plastic cell
101: plastic cell precursor
102: plastic cell unit
10: first sealing part
20: second sealing part
30: through-hole
200: heat source

What is claimed is:

1. A plastic cell comprising:
a first plastic substrate, a first transparent conductive layer, a fluid layer, a second transparent conductive layer, and a second plastic substrate, in this order,
wherein the plastic cell further comprises a sealing part that seals the fluid layer,
the sealing part has at least a first sealing part and a second sealing part,
the first sealing part is a sealing part which is formed by deformation of a part of the first plastic substrate or the second plastic substrate and which occupies 80% to 99.5% with respect to the entire volume of the sealing part, and
the second sealing part is a sealing part other than the first sealing part in the sealing part that seals the fluid layer.

2. The plastic cell according to claim 1,
wherein a part of the first sealing part and a part of the second sealing part are in contact with each other.

3. The plastic cell according to claim 1,
wherein at least one of the first plastic substrate or the second plastic substrate has a through-hole, and
the second sealing part is formed so as to close the through-hole.

4. The plastic cell according to claim 1, further comprising an orientation layer between the first conductive layer and the fluid layer and between the second conductive layer and the fluid layer, respectively,
wherein the fluid layer is a liquid crystal layer formed by using a liquid crystal composition containing a liquid crystal compound.

5. The plastic cell according to claim 2, further comprising an orientation layer between the first conductive layer and the fluid layer and between the second conductive layer and the fluid layer, respectively,
wherein the fluid layer is a liquid crystal layer formed by using a liquid crystal composition containing a liquid crystal compound.

6. The plastic cell according to claim 3, further comprising an orientation layer between the first conductive layer and the fluid layer and between the second conductive layer and the fluid layer, respectively,
wherein the fluid layer is a liquid crystal layer formed by using a liquid crystal composition containing a liquid crystal compound.

7. A method for manufacturing a plastic cell, comprising:
a precursor producing step of producing a plastic cell precursor having a first plastic substrate, a first transparent conductive layer, a fluid layer, a second transparent conductive layer, and a second plastic substrate, in this order; and
a sealing step of forming a sealing part that seals the fluid layer, in this order,
wherein the sealing part has at least a first sealing part and a second sealing part, and
the sealing step has a first sealing step of forming the first sealing part by thermal fusion welding of the first plastic substrate and the second plastic substrate so that the first sealing part occupies 80% to 99.5% with respect to the entire volume of the sealing part, and a second sealing step of forming the second sealing part, in this order.

8. The method for manufacturing a plastic cell according to claim 7, further comprising a step of removing air bubbles in the fluid layer, between the first sealing step and the second sealing step.

9. The method for manufacturing a plastic cell according to claim 7,
wherein the second sealing step is a step of forming a part of the second sealing part so as to be in contact with a part of the first sealing part.

10. The method for manufacturing a plastic cell according to claim 8,
wherein the second sealing step is a step of forming a part of the second sealing part so as to be in contact with a part of the first sealing part.

11. The method for manufacturing a plastic cell according to claim 7, further comprising a step of forming a through-hole in at least one of the first plastic substrate or the second plastic substrate,
wherein the second sealing step is a step of forming the second sealing part so as to close the through-hole.

12. The method for manufacturing a plastic cell according to claim 8, further comprising a step of forming a through-hole in at least one of the first plastic substrate or the second plastic substrate,
wherein the second sealing step is a step of forming the second sealing part so as to close the through-hole.

13. The method for manufacturing a plastic cell according to claim 7,
wherein the precursor producing step includes steps of:
forming the first transparent conductive layer on the first plastic substrate having an elongated shape;
forming the second transparent conductive layer on the second plastic substrate having an elongated shape;
disposing the fluid layer on the first transparent conductive layer; and
bonding the first plastic substrate, on which the first transparent conductive layer and the fluid layer are disposed, and the second plastic substrate, on which the second transparent conductive layer is disposed, to each other by a roll-to-roll process, to produce an elongated plastic cell precursor in which the first plastic substrate, the first transparent conductive layer, the fluid layer, the second transparent conductive layer, and the second plastic substrate are disposed, in this order.

14. The method for manufacturing a plastic cell according to claim 8,
wherein the precursor producing step includes steps of:
forming the first transparent conductive layer on the first plastic substrate having an elongated shape;
forming the second transparent conductive layer on the second plastic substrate having an elongated shape;
disposing the fluid layer on the first transparent conductive layer; and
bonding the first plastic substrate, on which the first transparent conductive layer and the fluid layer are disposed, and the second plastic substrate, on which the second transparent conductive layer is disposed, to each other by a roll-to-roll process, to produce an elongated plastic cell precursor in which the first plastic substrate, the first transparent conductive layer, the fluid layer, the second transparent conductive layer, and the second plastic substrate are disposed, in this order.

15. The method for manufacturing a plastic cell according to claim 9,
wherein the precursor producing step includes steps of:
forming the first transparent conductive layer on the first plastic substrate having an elongated shape;
forming the second transparent conductive layer on the second plastic substrate having an elongated shape;
disposing the fluid layer on the first transparent conductive layer; and
bonding the first plastic substrate, on which the first transparent conductive layer and the fluid layer are disposed, and the second plastic substrate, on which the second transparent conductive layer is disposed, to each other by a roll-to-roll process, to produce an elongated plastic cell precursor in which the first plastic substrate, the first transparent conductive layer, the fluid layer, the second transparent conductive layer, and the second plastic substrate are disposed, in this order.

16. The method for manufacturing a plastic cell according to claim 10,
wherein the precursor producing step includes steps of:
forming the first transparent conductive layer on the first plastic substrate having an elongated shape;
forming the second transparent conductive layer on the second plastic substrate having an elongated shape;
disposing the fluid layer on the first transparent conductive layer; and
bonding the first plastic substrate, on which the first transparent conductive layer and the fluid layer are disposed, and the second plastic substrate, on which the second transparent conductive layer is disposed, to each other by a roll-to-roll process, to produce an elongated plastic cell precursor in which the first plastic substrate, the first transparent conductive layer, the fluid layer, the second transparent conductive layer, and the second plastic substrate are disposed, in this order.

17. The method for manufacturing a plastic cell according to claim 11,
wherein the precursor producing step includes steps of:
forming the first transparent conductive layer on the first plastic substrate having an elongated shape;
forming the second transparent conductive layer on the second plastic substrate having an elongated shape;
disposing the fluid layer on the first transparent conductive layer; and
bonding the first plastic substrate, on which the first transparent conductive layer and the fluid layer are disposed, and the second plastic substrate, on which the second transparent conductive layer is disposed, to each other by a roll-to-roll process, to produce an elongated plastic cell precursor in which the first plastic substrate, the first transparent conductive layer, the fluid layer, the second transparent conductive layer, and the second plastic substrate are disposed, in this order.

18. The method for manufacturing a plastic cell according to claim 12,
wherein the precursor producing step includes steps of:
forming the first transparent conductive layer on the first plastic substrate having an elongated shape;
forming the second transparent conductive layer on the second plastic substrate having an elongated shape;
disposing the fluid layer on the first transparent conductive layer; and
bonding the first plastic substrate, on which the first transparent conductive layer and the fluid layer are disposed, and the second plastic substrate, on which the second transparent conductive layer is disposed, to each other by a roll-to-roll process, to produce an elongated plastic cell precursor in which the first plastic substrate, the first transparent conductive layer, the fluid layer, the second transparent conductive layer, and the second plastic substrate are disposed, in this order.

19. The method for manufacturing a plastic cell according to claim 13,
wherein the first sealing step is a step of continuously forming a plurality of the first sealing parts with respect to the elongated plastic cell precursor.

20. The method for manufacturing a plastic cell according to claim 19, further comprising a cutting step of cutting the elongated plastic cell precursor between the plurality of first sealing parts to produce a plastic cell unit, after the first sealing step and before the second sealing step.
